(19) United States
(12) Patent Application Publication
(10) Pub. No.: US 2013/0067450 A1
(43) Pub. Date: Mar. 14, 2013

(54) METHOD OF UPGRADING AN AIRCRAFT

(71) Applicant: Frédéric SAUGNAC, Toulouse (FR)

(72) Inventor: Frédéric SAUGNAC, Toulouse (FR)

(73) Assignee: AIRBUS OPERATIONS (SAS), Toulouse (FR)

(21) Appl. No.: 13/661,791

(22) Filed: Oct. 26, 2012

Related U.S. Application Data
(63) Continuation of application No. PCT/FR2011/000252, filed on Apr. 26, 2011.

(30) Foreign Application Priority Data
Apr. 29, 2010 (FR) 1001825

(51) Int. Cl. G06F 9/44

(52) U.S. Cl. 717/170

(57) ABSTRACT

An aircraft including a network of computers on board the aircraft, software applications loaded onto the computers of the network of computers. This method includes interrogating the computers of the network of computers on board the aircraft to know the configuration of the software applications loaded into the computers of the network of computers on board the aircraft, analyzing the configuration by at least one computer, identifying the software applications for which there exists a more recent version than the version loaded onto the network of computers on board the aircraft, computing a new software configuration for the aircraft by a computer on the ground, constructing a set of software applications, integrating updated software applications corresponding to a more recent version of a software application loaded into the computers of the network of computers on board the aircraft, loading the new configuration onto the computers on board the aircraft.

### CROSS-REFERENCE TO RELATED APPLICATIONS

This application is a continuation of and claims priority to PCT/FR2011/000252 filed Apr. 26, 2011 which claims the benefit of and priority to French Patent Application No. 1001825 filed Apr. 29, 2010, the entire disclosures of which are herein incorporated by reference.

### FIELD OF THE INVENTION

The present invention concerns a method of upgrading an aircraft or a fleet of aircraft.

### BACKGROUND

In a modern aircraft, the electronic equipment has a very important role. This equipment is managed by software means loaded onto computers which are linked to each other and form part of a network of computers on board the aircraft.

To improve the level of safety of the aircraft and/or its performance, the software applications, in particular the software applications managing the functions of the avionic systems of the aircraft, are regularly updated.

Thus, further to the sale of an aircraft by a manufacturer to an airline company, the latter is obliged to carry out maintenance operations requested by the manufacturer in order to improve the level of safety of the aircraft.

### SUMMARY

FIG. 1 is a diagram of two methods enabling an aircraft to be upgraded by performing an update of software applications in said aircraft. Generally, the manufacturer supplies an update of a software application, as well as the corresponding documentation, to a central data center of the airline company or more generally of the operator of the aircraft.

A first method is represented on the left side of FIG. 1. Two variants of this method are placed in parallel here. In one branch, the information is supplied by the central data center to a technical center which subsequently sends them to an operational control center which then delegates a technician to operate directly on the aircraft when it is on the ground. The double arrows indicate that the technician subsequently informs the operational control center in return which then advises the technical center thereof.

In the other branch, the procedure is substantially the same with different intermediaries. To be precise, there is to be found here a logistical and technical center in liaison with a (centralized) management department for maintenance of the fleet of aircraft which manages several maintenance workshops. A technician of such a workshop is then given the task of performing the upgrade on the aircraft.

The other variant shown in FIG. 1 illustrates a method in which the technician no longer moves around physically in the aircraft to perform the update of the software applications but that update is carried out remotely through the intermediary of a synchronous communication center. Document FR-2 914 804 discloses a communication system provided with means adapted to establish a network connection between the network of computers on board the aircraft and a network of computers on the ground which may be used to perform the update, illustrated in FIG. 1, of software applications in the aircraft

In this variant embodiment, although it is no longer necessary to involve a technician physically in the aircraft, numerous intermediaries participate in the method of updating the software applications loaded on board the network of computers of the aircraft.

More particularly, it is necessary to send among the various departments of the airline company (or other operator) operating the aircraft and to manage the information received from the manufacturer in order to upload the software in the aircraft. It is furthermore also necessary to keep up to date all the operator's documentation and to ensure the traceability of the operations which have been carried out.

The maintenance and the updating of the aircraft of a fleet of aircraft as described above implement two steps which are quite distinct with regard to responsibilities and the method. The first step is managed by the manufacturer of the aircraft. The latter decides upon a required modification for the aircraft it has constructed. It develops the modification for the solution found and certifies it with the certification authorities. The manufacturer thus shows that the new configuration proposed is compatible with the environment and with the configuration of the aircraft for which the modification is destined.

Once the solution has been developed and validated, the manufacturer prepares a pack, referred to as service bulletin, containing a description of the operations to conduct to perform the modification of the aircraft and also a physical element containing the software to change and furthermore containing corresponding documentation. The physical element containing the software depends on the size of the software and it may for example be a USB key (USB standing for “Universal Serial Bus”), a CD/DVD, etc. This pack is delivered physically to the company concerned that operates the aircraft. This delivery may also be performed electronically.

The second step is carried out under the responsibility of the operator of the aircraft, for example an airline company, or, when the aircraft is under heavy maintenance under the responsibility of the maintenance organization authorized for that. Similarly, this step may be performed by an authorized MRO (standing for Maintenance Repair Organization) when the aircraft is transformed for a change of operator. This is typically of the case for an aircraft hire company.

The operator receives the service bulletin and transfers it to a technical center (FIG. 1) in order for the operator to allocate and verify the compatibility of the service bulletin received with the environment of the aircraft of its fleet. Once the verifications have been performed and the service bulletin validated, a work request is sent to the maintenance management department of the operator's fleet. That department then defines the times (stopover, heavy maintenance visit, etc.) at which the aircraft may undergo that update and provides the workshop with the software element to install on the aircraft (USB key, DVD, etc.).

A maintenance workshop of the airline company or of a maintenance repair organization performs the requested task and downloads the software which is in the DVD or USB key (or other medium). The action is recorded and the configuration repository of the aircraft is updated. Of course, the technical center (and possibly other departments concerned) is kept informed of the upgrade which has just been carried out.

The update is carried out for the operator's entire fleet; In parallel, the documentation for the aircraft on the ground and/or on board the aircraft should also be updated.

Such a process, as described above and illustrated diagrammatically in FIG. 1 has numerous drawbacks.

A first drawback results from a difficulty in coordination between the operator of the aircraft and the manufacturer. A delay in the upgrading of the aircraft is identified when the operator delays installing it. To be precise, it may happen that the updates are delayed in being installed by the operator of the aircraft after reception of the service bulletin.

Similar tasks must be carried out by the manufacturer and by the aircraft operator. Two separate persons are thus called upon to perform the same task for an update. The manufacturer must in particular check the compatibilities of the service bulletins provided according to the known configurations of the aircraft. However, the manufacturer does not precisely know the configurations of the operator's aircraft and the operator has no obligation to make the configurations of its aircraft known to the manufacturer. Due to this, the manufacturer must perform a first task of analysis, then the operator's technical center is led to re-do the same task.

The cost of the structure to implement to be able to perform the updates requested by the manufacturer is high for the airline companies (operators) As a matter of fact, large teams in the airline companies must be dedicated to the management of the configurations of the aircraft of the fleet managed by the company.

It frequently occurs that several updates for software applications are to be made in parallel. The manufacturer cannot coordinate all its supplies to the airline companies. This is thus a source of efficiency loss for the operator.

In the aircraft, there is an ever increasing number of updates to perform. Furthermore, in the case of the reconfiguration of an aircraft for a change of operator, very often, the organization in charge of the re-configuration of the aircraft recomputes and defines the configuration to attain already carried out by the manufacturer. By way of illustrative example, an aircraft of the generation of aircraft commercialized under the registered trademark Airbus A340 comprises several tens of software applications exclusively downloadable with a portable downloading tool and with an operator on board. The maintenance operations of the fleet may in this case be undertaken solely during stopovers or at the time of maintenance visits of the aircraft when they are immobilized. In contrast, in new generation aircraft (for example commercialized under the registered trademark Airbus A380 or Airbus A350), more than a thousand software applications are to be found including for example the cabin systems and the operational systems. In order to reduce the costs of maintenance by the airline (or other) companies operating these aircraft, these aircraft are equipped with wireless solutions enabling update software applications to be remotely downloaded. The software applications capable of being updated are of two sorts:
either documentary databases to update regularly and in accordance with particular cycles entirely under the responsibility of the operator.
or software applications, called aircraft software applications, which are updated on request by the manufacturer or by the operator (airline company) to improve the performance and/or the safety of the aircraft. In both cases, the modifications to the configuration of the aircraft cannot be made without the agreement of the manufacturer who makes available to the operator a service bulletin containing the software to replace as well as the associated documents.

The present invention is thus directed to providing a method enabling the updating of an aircraft to be optimized. Preferably, such a method will enable savings to be made by reducing the cost of the updating operations. What is required here is to update different software applications which are used for the management of systems that are different from each other while taking care to avoid incompatibilities between those numerous software applications.

To that end, the present invention provides a method of upgrading an aircraft comprising a network of computers on board the aircraft and an avionic system, software applications being loaded onto computers of the network of computers on board the aircraft in particular for the management of the avionic system.

According to the present invention, this method comprises the following steps:
interrogating the computers of the network of computers on board the aircraft to know the configuration of said software applications loaded into the computers of the network of computers on board the aircraft,
analyzing said configuration by at least one computer,
identifying the software applications for which there exists a more recent version than the version loaded onto the network of computers on board the aircraft,
computing a new software configuration for the aircraft by a computer on the ground,
constructing a set of software applications, integrating updated software applications corresponding to a more recent version of a software application loaded into the computers of the network of computers on board the aircraft,
loading said set of software applications onto the network of computers on board the aircraft to obtain the new configuration on board the aircraft.

These successive steps enable an upgrading operation to be very substantially optimized since the updating of each software application is carried out here in the knowledge of all the versions of the software applications on board the aircraft. If the manufacturer itself performs the updating of the aircraft, since, better than anyone, it knows the aircraft and the software applications loaded on board the aircraft in all their versions, the new configuration loaded in to the aircraft may be optimized and costs to the operator managing the aircraft can therefore be avoided. These upgrades may also be installed more rapidly after their validation by the certification authorities.

The avionic system is considered here as being a set of electronic devices, including associated electrical elements, adapted to be used on board an aircraft in relation with piloting the aircraft. Such an avionic system comprises in particular radio circuits, automatic flight control circuits, on-board instrumentation, etc. The present invention above all concerns the updating of the software applications managing the different elements of the avionic system but may possibly also concern the management of equipment for the comfort of the passengers (lighting, air conditioning, etc.).

Furthermore, the different steps provided by the present invention may be carried out on the ground. It is meant here that these operations are not carried out on board the aircraft. Most often, these operations will be carried out in the offices of a technical department of the manufacturer of the aircraft.

In the method described above, there is preferably provided, at the end, a step of generating a configuration report attesting the update of the aircraft. Such a report enables the traceability of the operations that have been carried out to be ensured. Such a report will subsequently for example be archived by the manufacturer and by the operator of the aircraft.

According to a preferred embodiment of a method according to the invention, in parallel with the construction of a set of software applications, corresponding updated documentation is established. This documentation is preferably sent on board the aircraft at the same time as the updated set of software applications.

To remotely perform the upgrade according to the invention, the method of upgrading an aircraft advantageously employs a communication system comprising means adapted to establish a network connection between a network of computers on board the aircraft and a network of computers on the ground via at least one communication medium. Such a communication system is for example described in document FR-2 914 804. Preferably, the communication system is a wireless communication system between the aircraft and the network of computers on the ground in order to enable upgrade to be performed remotely, even when the aircraft is in flight.

When a system for communication between the ground and the aircraft is provided, the interrogation of the computers of the network of computers on board the aircraft to know the configuration of the software applications loaded into the computers of the network of computers on board the aircraft is advantageously carried out remotely using the communication system. The latter may also be used in order for the configuration obtained further to the interrogation of the computers of the network of computers on board the aircraft to be sent to a computer of the network of computers on the ground and/or in order for the loading of the new configuration onto the computers of the network of computers on board the aircraft to be carried out from at least one computer of the network of computers on the ground.

The analysis by at least one computer of the configuration of the software applications is for example carried out by a computer external to the aircraft.

To best take advantage of the means employed for the updating of the on-board software applications, the updating method according to the invention advantageously provides for documentation corresponding to the new configuration loaded onto the network of computers on board the aircraft to be loaded on board the aircraft.

### BRIEF DESCRIPTION OF THE DRAWINGS

Other advantages, objects and features of the present invention will emerge from the following detailed description, given by way of non-limiting example, relative to the accompanying drawings in which:

FIG. 1 illustrates upgrading operations carried out in an aircraft according to the state of the art.

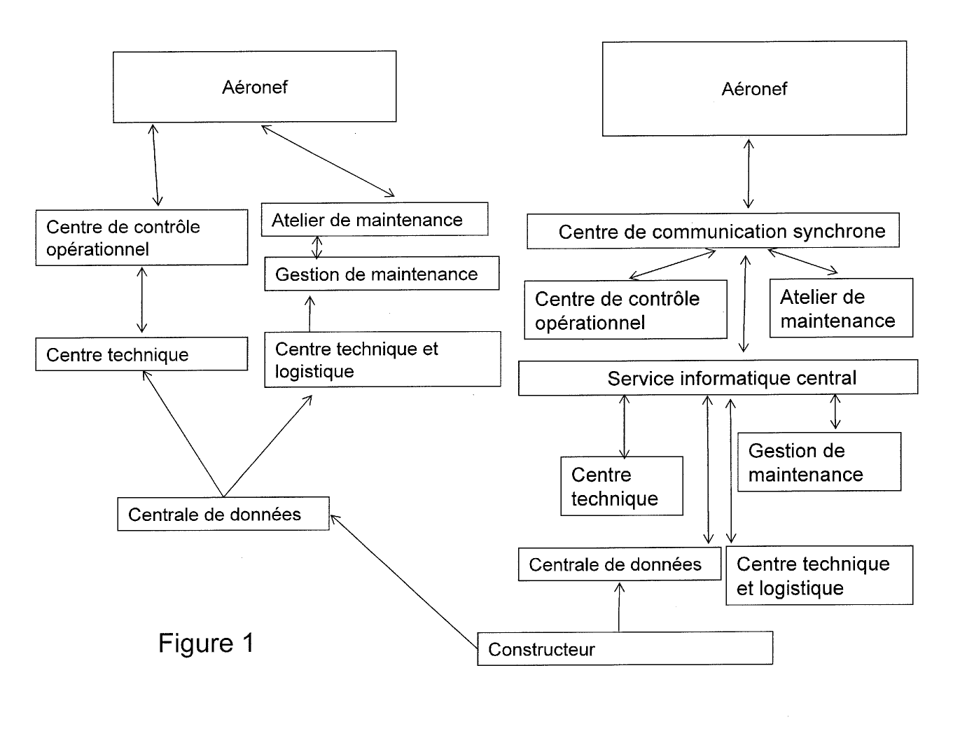

FIG. 2 illustrates an overview of a system used for the implementation of the invention, and

FIG. 3 illustrates operations performed for the updating of an aircraft according to the invention.

### DETAILED DESCRIPTION OF THE INVENTION

In accordance with the invention, a system for electronic upgrading for an aircraft is provided which is adapted to perform operations of updating software applications in particular so as to replace a software configuration loaded on board the aircraft by a configuration corresponding to a more recent version by an electronic process.

This upgrading system is based on an on-board infrastructure in an aircraft, that is to say an avionic system comprising in particular a set of functional entities of the aircraft, in particular entities controlled by software means, referred to hereinafter as “software applications”. These functional entities are first of all adapted for the piloting and the safety of the aircraft but may also concern the comfort of the passengers (management for example of the lighting and of the air conditioning in the cabin). In the following description, an infrastructure on the ground is also provided to prepare and update the software applications to be used on board and a connection infrastructure to exchange data between the infrastructure on the ground and the on-board infrastructure and to update the tools and stored data in the on-board infrastructure.

The infrastructure on the ground is, for example, present in a technical center of the manufacturer of the aircraft.

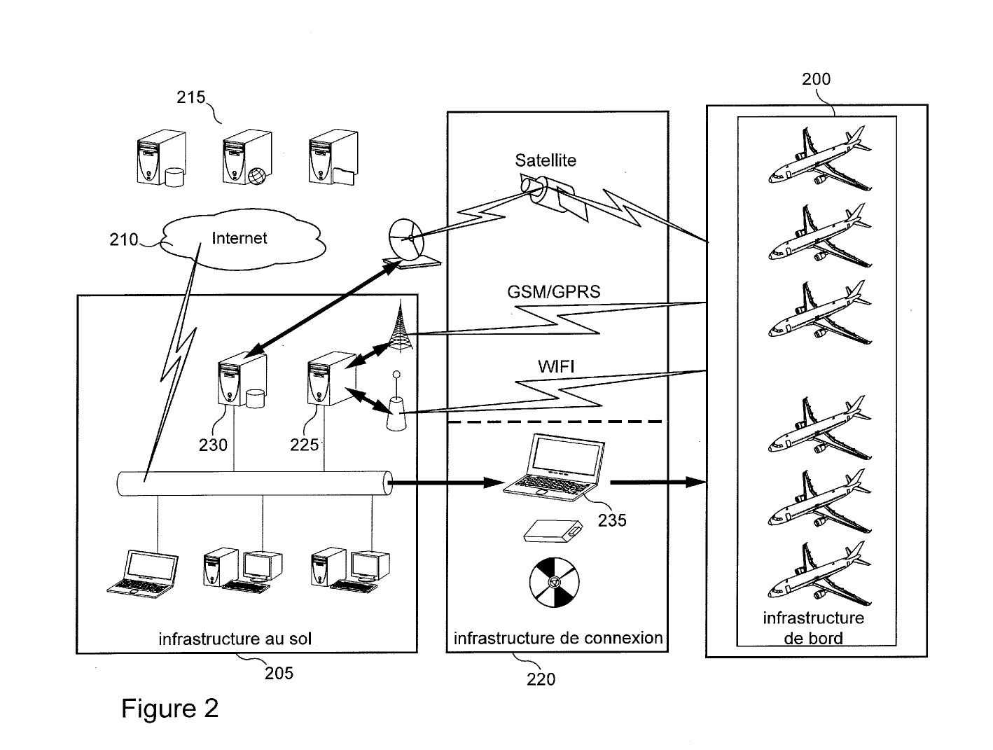

FIG. 2 illustrates an overview of a system that may be used by a method according to the invention.

Thus a set of aircraft 200 is represented corresponding to a type of aircraft constructed by an aeronautical manufacturer and an infrastructure on the ground 205 of that manufacturer. Each aircraft of the set of aircraft 200 comprises an on-board infrastructure comprising in particular a network of on-board computers in which are loaded software applications enabling electronic management of the avionic system of the corresponding aircraft. The infrastructure on the ground 205 comprises in particular a set of processing units interconnected via a telecommunication network. This network also comprises a connector 210, for example an Internet connection, in order to be connected to servers 215 of a centralized technical department of the manufacturer.

The infrastructure on the ground 205 is also connected via a communication network 220 (connection infrastructure) to the network of computers on board each of the aircraft. The communication network 220 is based for example on a wireless communication medium, for example WiFi, a mobile telephone communication medium for example GSM/GPRS or a satellite communication medium. Furthermore, an aircraft may be connected to the ground by a wire connection as a backup in case of unavailability of radio communication.

Thus the network of the infrastructure on the ground comprises in particular a server 225 adapted to send data to an aircraft and to receive data from an aircraft by satellite, and a server 230 adapted to send data to an aircraft and to receive data from an aircraft using a wireless or mobile telephone communication medium.

Furthermore, a portable medium 235 may be used, such as a portable computer, a USB key (USB standing for Universal Serial Bus), or a CD/DVD, in order to exchange data with the aircraft.

Thus, in accordance with the invention, the infrastructure of the aircraft is a mobile network adapted to communicate with the infrastructure on the ground of the manufacturer so as to create a continuity between the on-board infrastructure and the infrastructure on the ground.

According to a particular embodiment, the on-board infrastructure communicates with the infrastructure on the ground according to a synchronous communication mode. As the infrastructure of the aircraft comes to form a continuity with the infrastructure on the ground, it is possible to perform updates synchronously between the ground and the aircraft.

With such a system, a technician of the technical department of the aeronautical manufacturer may update the software applications and the data in the aircraft from the ground, an operation also called remote update.

According to a particular embodiment, on a communication medium between the on-board infrastructure and the infrastructure on the ground, in particular on a wireless network or on a mobile telephone network, a tunneling protocol is created, adapted to encapsulate the data to send in coded manner. This created network is called a virtual private network (denoted VPN). This network is said to be virtual since it links two physical networks by a communication medium that is not necessarily reliable, and private since only the computers of the network on each side of the virtual private network can access the data. Furthermore, it enables the exchanges over the communication medium that is not necessarily reliable to be rendered secure.

In this way, a secure link at less cost is created.

A system as described is used for the implementation of a method according to the present invention.

According to this method, an update of software applications on board the aircraft is carried out which is coordinated with the update of the operating and maintenance documentation in particular in order to increase the safety of the aircraft and/or its performance.

When a new version of a software application has been developed by the aeronautical manufacturer, for example in the centralized technical department of the manufacturer, the server 215 sends that new version to the infrastructure on the ground 205. This new version of the software application may then be downloaded onto all the aircraft of the set of aircraft 200. Below the software updating of a single aircraft of the set of aircraft 200 will be considered.

Via the connection infrastructure 220, the infrastructure on the ground 205 interrogates the computers of the network of computers on board the aircraft to know the configuration of the software applications loaded into the computers of the network of computers on board the aircraft. In modern aircraft, a very high number of items of equipment are managed by software applications and the configuration given by that interrogation thus concerns a high number of distinct software applications.

The configuration of the aircraft, that is to say essentially the indication for each software application of its version, is sent back via the connection infrastructure 220 to the network of computers on the ground (infrastructure on the ground 205).

A computer, which may for example be located with the infrastructure on the ground 205 but which may also be a computer of the centralized technical department of the manufacturer, analyzes the configuration of the aircraft.

This analysis then enables identification of the software applications for which there is a more recent version than the version loaded onto the network of computers on board the aircraft and corresponding to the configuration sent.

A new configuration for the aircraft integrating updated software applications may then be determined. This new configuration does not only concern a particular tool of the aircraft but all the tools on board the aircraft. It is thus possible to ensure compatibility for all the software applications of this new configuration. The latter, once it has been compiled, is downloaded on board the aircraft. Here too, in a preferred embodiment, the connection infrastructure 220 is used to perform, by a wireless connection, the downloading of that new configuration. The software applications on board the aircraft are thus updated and the upgrading of the aircraft is finished when those updates have been made.

In parallel or simultaneously to the updating of the software applications in the aircraft, the corresponding updating of the documentation may be made. The documentation on board the aircraft is updated and the new version of the documentation is communicated to the airline company that operates the aircraft.

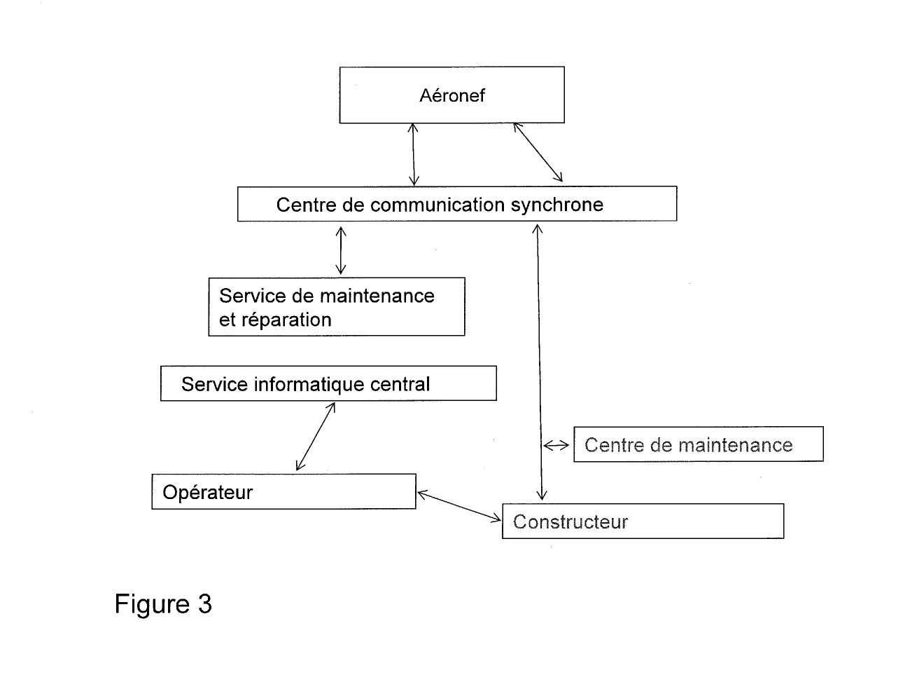

The implementation of this method according to the invention is advantageously carried out by the manufacturer of the aircraft concerned, who is the only one to have a good mastery of all the versions of the software applications loaded into the on-board infrastructure of the aircraft. However, it is clear that the updating is carried out with the agreement and cooperation of the company, for example an airline company, that operates the aircraft and which is called in the following part of the present description the operator. This method thus makes it possible to create an operation that is truly shared and collaborative between the manufacturer and the operator as explained below and illustrated in FIG. 3.

This collaboration enables the decisions for updating a complete fleet of aircraft to be optimized and coordinated.

The method according to the invention also enables the service to be customized for an operator. According to the operators' briefs, the software applications loaded into two aircraft of the same type may vary according to the operator managing the aircraft.

The operator may, by virtue of the invention, limit its technical teams by eliminating in particular double tasks of processing the service bulletins which are performed in the prior art (by the manufacturer and by the operator).

The method according to the invention furthermore optimizes the implementation of the upgrades relative to security and increases the security of the upgrading operations.

All the operations carried out at the time of the updating of the software applications on board the aircraft are so carried out of course in compliance with the regulations.

As the software updates for modern aircraft are in electronic form, it is possible for these updates to be organized and managed directly by the manufacturer under the supervision of the operator in order to comply with the regulations in force. Furthermore, modern aircraft comprise modern on-board communications means (Satcom SBB/UMTS Gatelink) which make it possible to interact directly as described above, whether the aircraft be in flight or on the ground. By virtue of its communication means, the manufacturer can request information from the aircraft and receive it practically in real time.

The method described earlier may then be reviewed with a very high level of interactivity between the manufacturer, the operator of a fleet and the aircraft, as explained below.

The manufacturer identifies a request for upgrade coming from the operator or from a decision of its own for upgrade of a software application. It has direct access on the one hand to the knowledge of the configurations of the operator's aircraft thanks to the secure communication device described above and on the other hand knows what the configuration is to be attained.

The manufacturer may thus prepare a customized batch for the operator and inform it that there is batch of software applications to implement on its fleet of aircraft.

The manufacturer may also produce different batches in order to adapt the update of the configuration to each of its aircraft.

On proposal by the manufacturer, the operator merely has to verify the quality of the data used by the manufacturer for the definition of its service bulletin and to accept the batch prepared the manufacturer or to request a modification to the content of that batch.

After accepting the update batch, the manufacturer may trigger the operations for loading on board the aircraft concerned the new configuration corresponding to the batches approved by the operator, in accordance with the maintenance department if necessary. When the new configuration, formed by the updated batch of software applications, is loaded on board the aircraft, they are should to be downloaded into the equipment to update, which may be carried out, according to the agreements, either by the operator, or by the manufacturer.

When the system on board the aircraft has been upgraded, the same automatic operation enables the associated aircraft documentation to be updated whether it be on board and/or centralized on the ground.

After performing the two operations (updating of the documentation and of the aircraft (software) system), a configuration report is sent to the operator and the manufacturer.

This principle of management of the upgrading of the fleet by the manufacturer makes it possible to:
operationally and cooperatively control the upgrading of the fleets and enable aircraft fleet upgrades that are faster and on a world-wide basis,
reduce the structural costs of the operator by simplifying the engineering work,
optimize the work of definition of the service bulletins for the manufacturer,
coordinate the upgrading of the aircraft and the updating of the corresponding documentation,
simplify and optimize the fleet upgrading tasks,
optimize the organization of work sites and maintenance visits with the deliveries of the upgrade batches by the manufacturer.

The clients of aircraft hire companies often request the hire companies to have an aircraft available rapidly. However, when the hire company retrieves an aircraft at the end of a hire contract, it is necessary to perform a reconfiguration of that aircraft to hire it out for another client in order for the aircraft to be in accordance with the requirements of the new client.

Such a reconfiguration of an aircraft to be able to be operated by a new airline company (a new client for the hire company) requires painstaking engineering operations and also work on the aircraft (reconfiguration) most often performed through sub-contracting to a specialist provider of aircraft maintenance and repair. Furthermore, the new generation aircraft managed essentially by software applications require multiple software tools on the ground to manage the operations of loading data and upgrading the fleet.

When a hire company makes an aircraft available to a client, who is most often an airline company, this may be for a short period of the order of a few months. In such a case, the operator does not generally wish to have to work on the aircraft other than to conduct repairs of failures. In this context, programmed maintenance visits are reduced to a minimum. If the aircraft is equipped for the implementation of the method according to the present invention described above, this becomes a real advantage.

To be precise the maintenance and repair department, or the hire company, may directly command a full reconfiguration from the manufacturer then request the manufacturer to perform the operations of remote upgrading during the exploitation of the fleet at any location in the world through reliance on the private aeronautical networks. The manufacturer may then offer a reliable and secure service for defining and downloading the software batch enabling the aircraft to be reconfigured without requiring additional work by the maintenance and repair department and without obliging the operator to deploy the full panoply of tools on the ground enabling the software updating of the fleet as well as the updating of the documentation including during its exploitation.

In the context of aircraft belonging to aircraft hire companies, the method according to the present invention enables the definition of the reconfigured aircraft to be made available rapidly and reliably to the maintenance and repair departments and then to the operators, and furthermore enables an increase in the security of the aircraft by controlling the activities of reconfiguration (definition of the service bulletins) and to provide the maintenance during the exploitation by delegating it to the manufacturer.

The present invention is not limited to the embodiments of a method described above. It also concerns the variant embodiments within the capability of the person skilled in the art in the context of the claims given below.

1. A method of upgrading an aircraft comprising a network of computers on board the aircraft and an avionic system, software applications being loaded onto computers of the network of computers on board the aircraft in particular for the management of the avionic system, comprising:
interrogating the computers of the network of computers on board the aircraft to know the configuration of said software applications loaded into the computers of the network of computers on board the aircraft;
analyzing said configuration by at least one computer;
identifying the software applications for which there exists a more recent version than the version loaded onto the network of computers on board the aircraft;
computing a new software configuration for the aircraft by a computer on the ground;
constructing a set of software applications, integrating updated software applications corresponding to a more recent version of a software application loaded into the computers of the network of computers on board the aircraft;
loading said set of software applications onto the network of computers on board the aircraft to obtain the new configuration on board the aircraft.

2. A method of upgrading an aircraft according to claim 1, characterized in that it further comprises at the end, a step of generating a configuration report attesting the update of the aircraft.

3. A method of upgrading an aircraft according to claim 1, characterized in that in parallel with the construction of a set of software applications, corresponding updated documentation is established.

4. A method of upgrading an aircraft according to claim 1, characterized in that it employs a communication system comprising means adapted to establish a network connection between a network of computers on board the aircraft and a network of computers on the ground via at least one communication medium.

5. An upgrading method according to claim 4, characterized in that the communication system is a wireless communication system between the aircraft and the network of computers on the ground.

6. An upgrading method according to claim 4, characterized in that the interrogation of the computers of the network of computers on board the aircraft to know the configuration of the software applications loaded into the computers of the network of computers on board the aircraft is carried out remotely using the communication system.

7. An upgrading method according to claim 4, characterized in that the configuration obtained further to the interrogation of the computers of the network of computers on board the aircraft is sent to a computer of the network of computers on the ground by the communication system.

8. An upgrading method according to claim 4, characterized in that the loading of the new configuration onto the computers of the network of computers on board the aircraft is carried out from at least one computer of the network of computers on the ground via the communication system.

9. An upgrading method according to claim 1, characterized in that the analysis of the configuration of the software applications by at least one computer is carried out by a computer external to the aircraft.

10. An upgrading method according to claim 1, characterized in that documentation corresponding to the new configuration loaded onto the network of computers on board the aircraft is loaded on board the aircraft.
